(19) United States
(12) Patent Application Publication
(10) Pub. No.: US 2022/0088684 A1
(43) Pub. Date: Mar. 24, 2022

(54) IN SITU MULTI-PHASE SENSING FOR 3D PRINTING

(71) Applicant: Divergent Technologies, Inc., Los Angeles, CA (US)

(72) Inventors: Michael KENWORTHY, Los Angeles, CA (US); Eric YANG, Los Angeles, CA (US); Narender LAKSHMAN, Los Angeles, CA (US); Chor Yen YAP, Los Angeles, CA (US); Simon PUN, Los Angeles, CA (US)

(21) Appl. No.: 17/478,525

(22) Filed: Sep. 17, 2021

Related U.S. Application Data
(60) Provisional application No. 63/080,621, filed on Sep. 18, 2020.

(51) Int. Cl. B22F 12/90; B23K 26/03; B23K 26/342; G01N 27/9013; B33Y 50/00; B33Y 30/00; B33Y 10/00; B22F 10/28; B22F 10/80

(52) U.S. Cl. CPC B22F 12/90; B23K 26/032; B23K 26/342; G01N 27/902; B22F 10/80; B33Y 30/00; B33Y 10/00; B22F 10/28; B33Y 50/00

(57) ABSTRACT

In various aspects, 3D printers, and sensor systems coupled to or integrated with the 3D printers are disclosed. The sensor systems may include image and second sensors for detecting potential defects or print artifacts. During printing, an energy beam source forms a weld pool by melting selected regions of print material, which solidifies to produce the build piece. The image sensor may image an area including the weld pool to determine a landing location of matter ejected during the heating of print material to form the weld pool. The second sensor may detect a defect in the build piece based on the determination of the landing location. Print operation may be suspended while the sensor data is used to repair the defect, after which 3D printing resumes. In this way, for example, high quality build pieces can be produced with reduced post-processing times, and hence a higher manufacturing throughput.

### CROSS-REFERENCE TO RELATED APPLICATIONS

This application claims the benefit of and right of priority to U.S. Provisional Patent Application No. 63/080,621, entitled “Realtime Quality Assurance Suited For High-Throughput Additive Manufacturing via Re-coater Mounted Sensing Systems”, filed Sep. 18, 2020, the contents of which are hereby incorporated by reference as if expressly set forth herein.

### BACKGROUND

### Field

The present disclosure relates generally to additive manufacturing systems, and more particularly, to processing three-dimensional (3D) printed parts.

### Background

AM systems, also described as three-dimensional (3D) printers, can produce structures (referred to as build pieces) with geometrically complex shapes, including some shapes that are difficult or impossible to create by relying on conventional manufacturing processes, such as machining. AM parts can advantageously be printed with diverse geometries and compositions using materials that allow the part to have specifically-tailored properties for a target application.

Various post-processing techniques may be used in AM systems after completion of the build piece to add or enhance features for the build piece, or to address imperfections or other artifacts in the build piece that may have been created during the print. Given the existing limitations in conventional post-processing techniques, which may result in quality problems, manufacturing latencies and other shortcomings, practitioners are continually seeking better ways to manufacture parts in a manner that helps achieve maximum manufacturing throughput while meeting quality requirements.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure is directed to multi-phase sensor systems for 3D printing, including a first sensor that senses during a first phase and a second sensor that senses during a second phase. In various embodiments, a multi-phase sensor system may include a first sensor that senses during a first time period, and a second sensor that senses during a second time period that may be mutually exclusive with or partially overlap with the first time period. In various embodiments, the sensors may be arranged at different locations. For example, the first sensor may be positioned to sense a larger portion of the printing area (e.g., by being positioned higher in a print chamber to have a larger field of view), and the second sensor may be positioned to sense a smaller portion of the printing area (e.g., by being positioned lower in the build chamber, closer to the build piece). The sensing of the second sensor may be, for example, based on the sensing information from the first sensor. For example, sensing information from the first sensor may be used to direct the second sensor to a specific area of interest sensed by the first sensor. The second sensor may provide, for example, a more detailed (e.g., higher resolution) sensing, which may for example include a different type of sensing than the first sensor. In various embodiments, the first sensor may be an image sensor (such as an optical camera, infrared imager, etc.) and the second-tier sensor may be another type of sensor (such as an eddy current sensor, etc.).

In various embodiments, an image sensor, or array thereof, may be positioned above a powder bed to image the bed as a weld pool migrates across the powder bed's surface. The weld pool may include a selected portion of the 3D printer's upper print layer(s) as it undergoes scanning by the printer's energy beam source. Because the energy beam has caused the print material in the weld pool to exceed its melting point, the weld pool may temporarily be in liquid form until it solidifies to form an intended part of the build piece. The weld pool can in this respect be a variable surface region of the powder bed, changing over time as different regions of deposited layers of print material are scanned. Images captured by the image sensor may be used to determine spatter of material ejected from weld pools caused by the intense heating of the high-energy beam, and the sensing information of the image sensor may be used to estimate a landing location of the ejected bit of material. The second sensor, such as an eddy current sensor, may be directed to the estimated landing location to perform additional sensing.

Imaging may be used to identify potential print defects such as matter ejected from the weld pool onto a landing location. The landing location may, for instance, be located on a different region from the build piece in progress. The eddy current sensor may detect potential defects not just on, but also within, a volume of print material including a build piece. As mentioned above, in various embodiments, a second sensor like the eddy current sensor may obtain from the image sensor the landing location information of the particle ejected from the weld pool. The particle may include a ceramic, an intermetallic, or the like. The eddy current sensor can more specifically identify features like the location, orientation or size of the particle. These identified features and other criteria can be used by one or more processors to determine a course of action, if any, to address the defect. In various embodiments, the processor(s) may suspend 3D printing while the defect is removed or repaired. Printing can thereafter resume. In other embodiments, the processor may physically mark the defective area so that the site can be identified and repaired later.

The sensors may detect other types of defects. Examples of defects include voids, (which can be a source of crack initiation in the final part if left unaddressed) inclusions (which can include the ejected matter above, and other foreign particulates), regions of unsintered or partially sintered powder in the build piece (that should otherwise be solidified in that region), geometrical anomalies in the build piece (e.g., a jagged edge instead of a curve), and others. The first and second sensors can work in concert to enable the processor(s) to identify these defects and provide instructions for any necessary repair or removal, whether during or after the print.

In one aspect of the disclosure, a sensor system for a three-dimensional (3D) printer includes a first sensor configured to determine a landing location of matter ejected during heating of print material to form a weld pool. The weld pool defines a portion of a build piece once the weld pool hardens. The sensor system includes a second sensor configured to detect a defect in the build piece based on the determination of the landing location.

In another aspect of the disclosure, a three-dimensional (3D) printer includes a processor, a build plate, and a recoater. The recoater is configured to successively deposit layers of print material onto the build plate. The 3D printer further includes an energy beam source. The energy beam source is configured to form a weld pool by heating selected regions of the print material in each layer to form a build piece. The 3D printer further includes an optical sensor. The optical sensor is configured to image an area including the weld pool to determine a landing location of matter ejected during heating of the print material to form the weld pool. The 3D printer also includes a non-optical sensor. The non-optical sensor is configured to detect a defect in the build piece based on the determination of the landing location.

In still another aspect of the disclosure, a method for 3D printing a build piece is disclosed. Layers of print material are successively deposited onto a build plate. A weld pool forms on the layers using an energy beam to heat the print material. The weld pool defines a portion of a build piece once the weld pool hardens. A first sensor is used to determine a landing location of matter ejected during heating of the print material to form the weld pool. A second sensor is used to detect a defect in the build piece based on the determination of the landing location.

One or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Various aspects of multi-sensing technologies for print artifacts in 3D printing and for addressing said defects in situ (in place) will now be presented in the detailed description by way of example, and not by way of limitation, in the accompanying drawings, wherein:

FIG. 1 is a side cross-sectional view of a dual-sensor system coupled to a 3D printer.

FIG. 2 is a side cross-sectional view of another dual-sensor system coupled to a 3D printer.

FIG. 3 is a perspective posterior view of a recoater with an integrated eddy-current sensor.

FIG. 4A is a rear perspective view of a recoater with an integrated eddy current sensor.

FIG. 4B is a perspective view of an exemplary blade or wiper that connects to the recoater of FIG. 4A.

FIG. 5 is a top view of an example recoater for use in various configurations.

FIG. 6 is a flow chart of an exemplary action of an eddy-current sensor.

FIG. 7 is an illustrative side cross-sectional view of a weld pool in multiple layers.

FIG. 8 is a top view of a 3D printer powder bed and recoater illustrating the use of eddy currents to help remove defects.

FIG. 9A is a side view of two cameras oriented to image a powder bed surface in three dimensions.

FIG. 9B is a front perspective view of the two cameras of FIG. 9A.

FIG. 10 is a conceptual diagram with different optical images of a trajectory of matter ejected from a weld pool.

FIG. 11 is a flowchart of methods for using a combined sensor system to identify and repair defects during printing.

FIG. 12 is another flowchart of methods for using a combined sensor system to identify and repair defects in a 3D printer.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The terms “exemplary” and “example” used in this disclosure mean “serving as an example, instance, or illustration,” and should not be construed as excluding other possible configurations or as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

The combined sensor apparatuses and methods for multi-phase sensing, which may include identifying and potentially repairing potential defects, in this disclosure will be described in the following detailed description and illustrated in the accompanying drawings by various elements such as blocks, components, circuits, processes, algorithms, etc. These elements may be implemented using electronic and mechanical hardware, computer software, or any combination thereof.

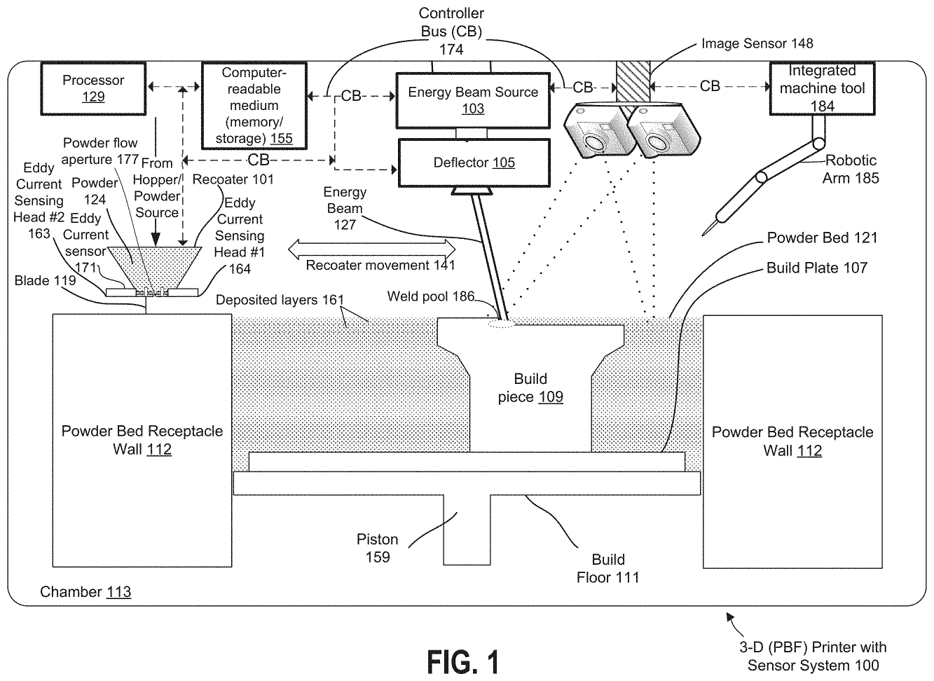

By way of example, an element, or any portion of an element, or any combination of elements may be implemented using one or more processors. Examples of processors, such as that shown in element 129 of FIG. 1, for example, include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The one or more processors may be part of a workstation or a server computer configured to perform the routines described herein. The one or more processors may be included within a separate combined sensor system (including, e.g., imaging sensors, optical sensors, infrared sensors, eddy-current sensors, acoustic sensors capacitive sensors, pressure sensors, and the like, or any combination thereof) mountable on, or integrated with, a 3D printer. The one or more processors may be operatively or electronically coupled to digital and analog circuits, memories, and any other circuits used of operating the one or more processors, including data busses for connecting the components.

The one or more processors may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, object code source code, or otherwise.

Accordingly, in one or more example embodiments herein for providing sensor systems and 3D printers having the sensor systems, for 3D printing parts (build pieces), imaging print artifacts, sensing spatter, determining landing points of the spatter, combining received data to use in performing responsive actions such as automated in situ repairs, manipulating eddy currents for adjusting magnetic fields, removing inclusions, filling voids, melting unsintered or partially sintered print material, and performing other functions described herein, the functions may be implemented in hardware, software, or any combination thereof. If implemented in software, the functions may be stored on or encoded as one or more instructions or code on a computer-readable medium. Computer-readable media, as described below with reference to FIG. 1, includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer. For purposes of this disclosure, the computer that may include the one or more processors may be directly or indirectly connected to a 3D printer, such as a powder bed fusion-based printer.

This principles of this disclosure may be applicable to a variety of 3D printer types, including but not limited to powder bed fusion (PBF) printers including selective laser sintering (SLS), direct metal laser sintering (DMLS), selective laser melting (SLM), electron beam melting (EBM), etc.

The present disclosure is directed to advanced sensor systems that enhance the quality and accuracy of data generated during 3D printing. The sensor systems can include a combination of optical and non-optical sensors that provide real-time data about the presence of undesirable inclusions, voids, and other defects in the part being printed. A common problem in certain 3D printers is spatter, or matter ejected during the heating of print material to form a weld pool. Matter can be ejected, for example, from the area of the weld pool itself as the print material is heated quickly by an energy beam. Matter can be ejected, for example, from the area around the weld pool as the weld pool moves quickly across the surface of a layer of the print material. For example, metal powder in area around the melt pool may be thrown upwards by the intense heat and motion of the melt pool. Ejected matter may fall into another region of the build piece. For example, ejected matter may land at a location in the powder bed that will be, but has not yet been, fused to create part of the build piece. In other words, the ejected matter may land on powder that will be fused. In this case, for example, the ejected matter might cause a defect in the build piece when the powder is fused. For example, the ejected matter might cause an inclusion in the build piece when the fused powder solidifies. Notably, once the ejected matter becomes the defect upon solidification, the defect may not be able to be imaged, e.g., by an image sensor, such as an optical sensor. In addition to identifying the defects or other foreign particles, the sensor systems described in various configurations herein can provide information concerning their trajectory, velocity, landing location, size, orientation, composition, weight, and other characteristics. The 3D printer may use this data together with existing print specifications for the part (e.g., the CAD model, manufacturer's specifications, etc.) to evaluate whether identified defects or other artifacts require fixing or removal, including when any such actions should be initiated, if at all.

In some cases, implementing corrective measures during the print may be most useful while those defects are most accessible. Accordingly, in various embodiments, the data from the combined sensor system enables the 3D printer and its related hardware components to repair the defect during printing, such as by temporarily suspending the print job and extracting an inclusion (e.g., an undesirable ceramic or intermetallic matter particle) from the build piece without adversely affecting surrounding regions of the part.

As another example, the 3D printer may identify a defect in or near real time using combined information from different types of sensors. The processor may instruct the 3D printer to suspend the print. The 3D printer may repair the (then easily-accessible) defect, or extract the foreign matter, using a CNC machine tool, automated robotic arm, or other mechanism such as a brush or blade. In some arrangements, the processor may instruct the recoater to make selective deposits of additional print material, after which the processor may activate the 3D printer's laser or electron beam source to selectively re-melt and solidify the deposited powder. The energy beam source may also be used to melt an identified pocket of unsintered powder that is already present in the powder bed.

Immediately following the repairs or shortly thereafter, 3D printing can resume. In other arrangements, the processor may determine based on the detailed data that a fix is not needed and that the identified defect is innocuous and not harmful to the build piece. The processor(s) can therefore evaluate the diverse data about the defect to its benefit, determining in these cases that the print can proceed without further interruption.

Addressing fixes during the print may be quicker because the 3D printer has direct access to the problem. The system does not in that case have to unearth numerous layers before reaching the problem area, as may otherwise be required if every identified problem is just deferred until post-processing. Here, by contrast, post-processing times can beneficially be reduced, or reserved to other tasks. Another problem faced by manufacturers is whether the defect can even be detected or accessed at the post-processing stage in the first place. If the defect is buried in the middle of hardened metallic layers, for example, the defect may be difficult or impossible to detect, and even if it is detected might be infeasible to fix. The combined sensor system of the present disclosure can, however, provide additional, more diverse data to the processor that characterizes the nature of the defect. The 3D printer can better determine an appropriate time for the fix that increases quality assurance without causing undue inefficiencies.

In further embodiments, the 3D printer sensor system as disclosed herein also may include superior techniques to both identify and address defects. For example, an integrated sensor system may include optical sensors that are oriented to enable a three-dimensional representation. With these 3D views, the precise location of ejected material can be facilitated. Further, such defects can be neutralized quickly or immediately. In some embodiments, upon determining a landing location of ejected a particle of matter, the 3D printer may use an eddy current sensor to determine whether the particle creates or will create a defect in the build piece before they become deeply lodged underneath the layers.

FIG. 1 is a side cross-sectional view of a dual-sensor system coupled to a 3D printer 100. In an aspect of the present disclosure, the 3D printer system may be a powder-bed fusion (PBF) system 100. FIG. 1 shows PBF system 100 with its different components for performing different stages of operation. The particular embodiment illustrated in FIG. 1 is one of many suitable examples of a PBF system employing principles of this disclosure. It should also be noted that elements of FIG. 1 and the other figures in this disclosure are not necessarily drawn to scale, but may be drawn larger or smaller for the purpose of better illustration of concepts described herein. PBF system 100 can include a recoater 101 that can deposit each layer of metal powder (the print material in this example), an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls of the powder bed receptacle 112 are shown in cross-section. In practice, the powder bed receptacle walls 112 may or may not form a closed perimeter, depending on the type and features of the 3D printer. The walls 112 generally define the boundaries of the powder bed receptacle, the latter of which is sandwiched between the walls 112 from the side and abuts a portion of the build floor 111 below. Build floor 111 can progressively lower build piece 107 so that recoater 101 can deposit a next layer. The entire mechanism may reside in a chamber 113 that can enclose the other components, thereby protecting the equipment, enabling atmospheric and temperature regulation and mitigating contamination risks.

Recoater 101 can receive print material from a separate hopper (not shown). In some arrangements, the hopper may be integrated with or part of recoater 101. A separate depositor may also be included in some 3D printers. The purpose of all of these embodiments, in general, is to provide print material to the powder bed 121. In the embodiment shown, recoater 101 is separate from the hopper. In other embodiments, the hopper may be configured as a large drum or source of metal powder. Recoater 101 contains a powder 124, such as a metal or alloy-based powder, and a leveler or blade 119 that can level the top of each layer of deposited powder 124 as it flows through powder flow aperture 177 during a recoating cycle. The hopper may act as a powder source that periodically fills the recoater 101 with powder (e.g., during a scan cycle) to enable the recoater 101 to deposit powder layers across the total necessary span of the powder bed 121.

During the recoating cycle, the energy beam 103 may be off while the recoater 141 moves horizontally along the direction of arrow 141. In so doing, recoater 101 may deposit a layer 161 of material. The thickness of layers 161 is exaggerated in the figure for clarity. That is, recoater 101 is positioned to deposit powder 124 in a space created over the top surfaces of build piece 109 and powder bed 121 and bounded by powder bed receptacle walls 112. In this example, recoater 101 progressively moves over the defined space while releasing powder 124 via powder flow aperture 177. As noted above, blade 119 can level the released powder to form a powder layer 161 that leaves a surface of the powder bed 121 configured to receive fusing energy from energy beam source 103 in a subsequent scanning cycle.

In some cases, the recoater 101 is configured bi-directionally, meaning that recoater 101 may deposit a layer 161 of powder in two directions. That is, in addition to depositing material as it moves from left-to-right along the axis of arrow 141, recoater 101 may also deposit a layer of powder through powder flow aperture 177 when it travels from right to left along the same. In this bi-directional embodiment of recoater 101, an additional blade (not shown) similar to blade 119 may be arranged opposite blade 119 and may be configured to level powder deposited when the recoater 101 is moving from right to left. Thus, for example, a first recoater cycle may occur where recoater 101 deposits a first layer 161 moving left to right, followed by a scanning cycle. Then the recoater 101 can perform another scan as it moves from right to left to deposit another layer 161 of powder. Another scanning step can occur, and so on until build piece 109 is completed.

In this way, one scan cycle may follow every recoater cycle. During the scan cycle, the energy beam source 103 uses deflector 105 to produce an energy beam 127 (e.g., a laser beam) for selectively fusing a cross-sectional region of the uppermost layer that will become a portion of build piece 109. The regions of the top layer that will not be part of the finished build piece may be left unsintered.

FIG. 1 illustrates a time at which PBF system 100 has already deposited and fused slices (i.e., cross-sections of the build piece 109) in multiple layers (e.g., two hundred (200) individual layers) to form the current state of build piece 109, e.g., formed of 200 individual slices. The multiple individual layers 161 already deposited have created a powder bed 121, which includes powder that was deposited but not fused. While energy beam source 103 scans the top layer of the build piece, the energy beam 127 may be powerful enough to re-melt material in one or more previous layers of the build piece underneath. The 3D printer 100 is generally configured to account for this phenomenon where it occurs, to yield a build piece with the intended features (e.g., density, depth, etc.) by correctly modulating the energy of the laser or other energy source.

During this scanning cycle, energy beam source 103 forms a weld pool 186, which includes a region of powder 124 that is scanned by the energy beam 127, and that temporarily melts as a result. The melted region in the weld pool 186 soon thereafter can solidify as intended to form a permanent part of build piece 109.

Each time energy beam source 103 completes the scan of a layer, build floor 111 can lower by a thickness of one of the powder layers 161. The lowering of build floor 111 causes build piece 109 and powder bed 121 to drop by that powder layer thickness, so that the top of build piece 109 and powder bed 121 are lower than the top of powder bed receptacle wall 112 by an amount equal to the thickness of one of the powder layers 161. In this way, for example, a space with a consistent thickness equal to this powder layer thickness can be created over the tops of build piece 109 and powder bed 121.

In various embodiments, the deflector 105 can include one or more gimbals and actuators that can rotate and/or translate the energy beam source to position the energy beam. In various embodiments, energy beam source 303 and/or deflector 305 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP). In embodiments incorporating electron beams as the energy source, deflector 105 can include deflection plates that can generate an electric field or a magnetic field that selectively deflects the electron beam to cause the electron beam to scan across areas designated to be fused. Deflector 105 can include an optical system that uses reflection and/or refraction to manipulate a laser beam to scan selected areas to be fused. Deflector 105 may be a lens, mirror, or another device that the processor can steer using its magnetic fields, for example, to direct the flow of an electron beam source. Because the electrons are charged particles, the processor can control their flow via the electric and magnetic fields. Where a laser is involved, which includes uncharged photons, a lens or mirror of the defector 105 can be directed in some embodiments to use reflection, refraction and other techniques to properly focus the laser on the correct area of the surface of the powder bed 121.

Also shown in FIG. 1 is a processor 129. Processor 129 is connected to a memory (computer-readable medium) 155 via a controller bus 174. Processor 129 may in fact be a plurality of processors. Processor 129 may perform the functions of a print controller. As shown by the dashed line representing the controller bus 174, processor 129 is also coupled to recoater 101, to energy beam source 103, and to deflector 105. Processor 129 may be distributed in different locations of the 3D printer, performing local functions in that manner. For example, processor 129 may include more than one general or special purpose processors distributed (e.g., in the form of logic circuitry, digital signal processors, field programmable gate arrays, application specific integrated circuits, and other digital technologies) across relevant portions of the 3D printer 100. In other embodiments, processor 129 may be part of a separate computer coupled to, and PBF printer system 100.

In some embodiments, processor 129 may retrieve in the memory 155 a computer-aided design (CAD) model representing the build piece 109. Processor 129 may compile the CAD model into a number of executable instructions corresponding to slices that the processor can use to print the build piece 109 using the scanning and recoating techniques described above. In some embodiments, the CAD model is already compiled by another source, and the compiled instructions are provided to processor 129 via memory 155. Processor 129 can use the print instructions to direct the behavior of the recoater, the energy beam source, and the deflector to properly produce build piece 109.

In various embodiments, PBF printer system includes an image sensor 148, which is positioned in this arrangement at the surface of chamber 113, as two adjacent cameras. In various embodiments, image sensor 148 may be, for example, a single image sensor (such as a single camera). In various embodiments, a plurality of image sensors or video monitors may be positioned at any relevant portion of the PBF system 100 to enable the image sensor 148, for example, to provide multiple views of the weld pool and its vicinity. Image sensor 148 may be communicatively coupled to processor 129 via controller bus 174. Image sensor 148 may be selectively activated, or in other cases, they may be powered on during the entire print job. Image sensor 148 may image the powder bed and may be automatedly controlled in some arrangements to follow the weld pool.

Image sensor 148 may take snapshots or make continuous views in the area of the weld pool or other parts of the powder bed. In various embodiments, image sensor 148 may be positioned to take images along the side of the powder bed so that multiple angles may be recorded. In some variations described further below, image sensor 148 may be oriented in a manner that can provide the processor with three-dimensional images of the weld pool and other portions of the powder bed. Both image sensor 148 and processor 129 may be communicatively coupled to an integrated machine tool 184 including robotic arm 185, so that in some embodiments, automated fixes may be performed in or near real time as described further below.

Referring still to FIG. 1, image sensor 148 may in various embodiments detect different types of ejected material from the weld pool and area around the weld pool during the scanning cycle. The image sensor 148 may be configured to monitor the progress of the weld pools and identify any hot objects leaving the vicinity. The heat of an object may be represented in image sensor 148 by its brightness, for example. The ejected material may also be referred to as “spatter” or “weld spatter”. The spatter include particles that may be categorized based on various characteristics which include, among others, orientation, trajectory, velocity, size and composition. Composition may necessitate a spectral analysis, which can be performed by the processor 129 or it may be performed offline. In such embodiments, compositional data can be offloaded to another computer before composition is determined.

In some embodiments, image sensor 148 may be arranged on a swiveling or moving structure, such that image sensor 148 can be moved to different desired positions above the powder bed 121 or can be rotated above the powder bed 121.

3D printing system 100 may further include an eddy current sensor 171. While the eddy current sensor 171 can be coupled to different structures in various embodiments, in the embodiment of FIG. 1, the eddy current sensor 171 is coupled to recoater 101. A first sensing eddy current sensing head #1 (164) may be integrated in the housing of a first side of recoater 101. A second eddy current sensing head #2 (163) may be integrated in the housing of a second side of recoater 101. These orientations enable the eddy current sensing heads 1 and 2 (164 and 163) to be positioned directly over the powder bed when the recycling step is performed.

In operation, an eddy current sensor 171 may induce a changing magnetic field, which can penetrate the layers 161 of the powder bed 121. This induced magnetic field can create eddy currents within the conducting metallic powder layer 121, including in the solid material in the build piece 109. The measured properties associated with the eddy currents (such as the magnitude and direction of the opposing magnetic field created by the currents) can be used to determine features of the build piece not only on the surface of, but also within, the build piece. In FIG. 1, the eddy current sensor 171 moves with the recoater 101.

In various embodiments, the eddy current sensor 171 (via processor 179 or its own internal circuitry) can receive data from the image sensor 148 relating to a landing location of ejected matter. During an ensuing recycling period, the eddy current sensor 171 can use the sensing heads 163 and 164 to measure features related to the ejected matter, including size, shape, geometry, density, and chemical composition. The eddy current sensor 171 can send its measurements to the processor 129. The processor 129 can use these measurements along with the data from the image sensor 148 to make real time determinations including (i) whether some type of on-site repair or removal is necessary; (ii) if a fix is necessary, whether the fix should be implemented immediately, at a specific time, or after the print in post-processing, and (iii) the nature and extent of the fix. As for (iii), for example, the fix may involve fusing a crack, adding and sintering material to fill voids, or removing ejected matter, among other possibilities.

In various embodiments, the image sensor 148 and eddy current sensor 171, together with the integrated machine tool 184 including robotic arm 185 and processor 129, can form a closed loop wherein the processor 129 can make on the fly assessments about the need for repairs. Processor 129 can further communicate with robotic arm 185 over controller bus 174. Processor 129 can, for example, submit commands for the 3D printer to suspend printing (if necessary), and to use robotic arm 185 to perform machining in the powder bed 121 or the build piece 109 to fix a defect, remove an inclusion, etc. In some configurations, the integrated machine tool 184 with the robotic arm 185 may be configured to perform conventional types of machining operations. For example, the robotic arm 185 may be configured to perform subtractive manufacturing to remove spatter that became fused to the build piece 109. The 3D printer may then apply “patches” to add and solidify material to the build piece where the spatter was removed, before the 3D printer resumes full print mode. In the case of partially sintered or unsintered material in the build piece 109, the robotic arm 185 may be configured to remove just enough material to access the area of partially sintered or unsintered powder, after which the 3D printer may apply an energy beam source 103 to the region to solidify the powder and remove the defect.

While integrated machine tool 184 and its robotic arm 185 can be an effective way to perform in situ repairs, some 3D printers may lack this equipment. In that case, the repairs can be performed using different types of equipment or even external equipment, so that the machine tool 184 may be omitted in some embodiments.

In various embodiments, other types of non-optical sensors may be used in the 3D printer 100. Exemplary types of sensors may include acoustic sensors, capacitive sensors, seismic sensors, etc. These different sensors may be used together with (e.g., to complement), or in lieu of, eddy current sensor 171 to feed information to the processor 129 about defects that they uncover. The defects may include not only inclusions as noted, but other problems such as subsurface voids (empty regions below the surface of the powder bed 121), or a region of partially sintered or unsintered print material that should otherwise be solidified in the build piece. Capacitive sensors function by detecting changes in the electric field. In some embodiments, capacitive sensors may be placed relatively close to a surface of the powder bed such that a sufficient dielectric can be implemented to allow an alternating source to measure an electric field of the dielectric during operation of the capacitive sensor. Likewise, in practical implementations, the acoustic sensor is placed sufficiently close to the powder bed 121 to render reliable acoustic measurements. Acoustic wave devices or sensors may be integrated in the respective ends of the re-coater, and may use piezoelectric material to apply an oscillating electric field to the powder bed region. Changes can be detected based on changes to the field. Some acoustic sensors rely on changes in audible noise to detect the presence of potential defects or foreign matter.

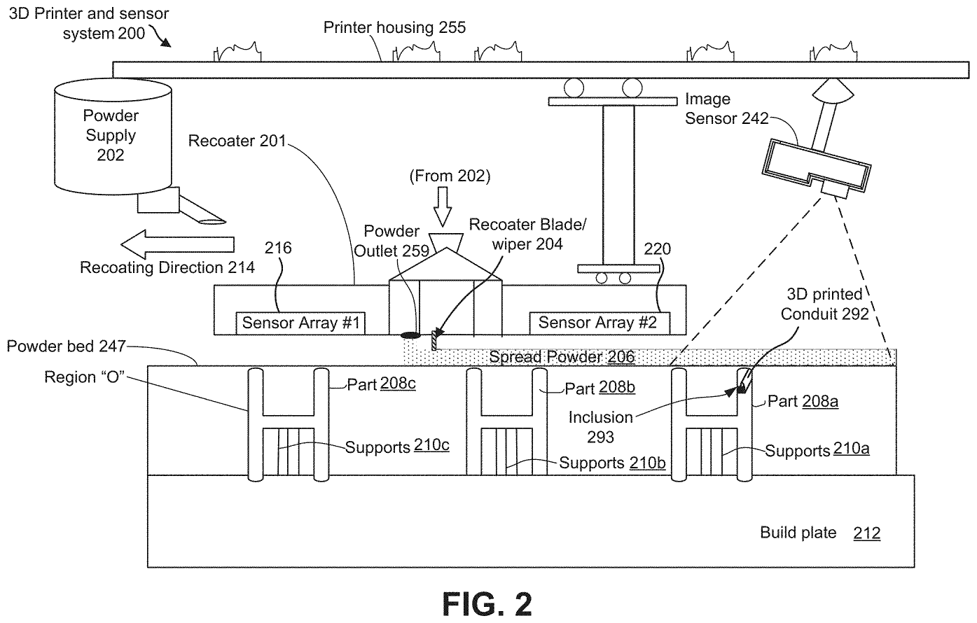

FIG. 2 is a side cross-sectional view of a 3D printer and sensor system 200. As before, a build plate 212 is used to support the print material and build piece(s). After the processor 129 (FIG. 1) has compiled the print instructions, a recoater 201 can successively deposit print layers onto the build plate 212 to form powder bed 247. Between each deposition cycle, an energy beam source (not shown) can be used to effect a corresponding scan cycle in which select regions of the layer are solidified. Three build pieces 208a-c shown each include a set of support structures, respectively labeled as 210a, 210b, and 210c.

The support structures 210a-c are not part of the build pieces 208a-c, and may be removed (e.g., via dissolution, controlled physical force, etc.) after the print is completed. Portions of 3D print parts exceeding a certain angle (e.g.,) 45° may require support structures so that the members do not deform due to thermal effects encountered during the 3-D printing process or otherwise lose their dimensional integrity under their own weight. In some printers, portions of a build piece that extend by an amount greater than 45° from a vertical position—such as the horizontally disposed “Region ‘O’” segment of build piece 208c—may require support structures 210a-c to maintain the integrity of the respective build pieces 208a-c. This helps prevent the build pieces from deforming due to lack of sufficient thermal conduction or other forces. In these cases, the supports 210a-c can be removed after printing.

Recoater 201 may receive print material from powder depositor 202, not shown for clarity. Recoater 201 may include a powder outlet 259 for spreading powder during the recoating step. As recoater 201 proceeds towards recoating direction 214 over the powder bed 247, the recoater 201 leaves spread powder 206 in its wake. Recoater blade 204 may level the powder as it is deposited to ensure that the new powder layer is evenly distributed across the powder bed. As in the 3D printer 100 of FIG. 1, the spread powder 206 and build pieces 208a-c are supported by a build plate 212.

3D printer and sensor system 200 further includes sensor arrays # 1 and 2 (216 and 220), which in the present embodiment include eddy current sensors. In various embodiments, sensor arrays 216 and 220 may be, for example, acoustic sensor arrays, capacitive sensor arrays, optical sensor arrays, etc. 3D printer and sensor system 200 also includes a printer housing 255, only a portion of which is shown to avoid unduly obscuring the concepts of the disclosure. Printer housing 255 may, for example, be a portion of a print chamber or outer wall. The interior of printer housing 255 may include an image sensor 242, such as an optical sensor (e.g., a camera or video monitor), an infrared sensor, etc., which may be pivotally or movably affixed on a surface of the inner housing. Image sensor 242 may, like in FIG. 1, image a weld pool or a portion of a recoated layer, for example. Sensor arrays 216 and 220 may use information provided by image sensor 242, including data identifying a trajectory or a landing location for ejected matter particles. As described above, sensor arrays 216 and 220 may identify more detailed information about the ejected particles and may provide the information to a processor or processor array to determine what kind of response is appropriate, if any.

Eddy current (EC) sensors, such as in sensor arrays 216 and 220, need not be limited to examining landing areas of ejected matter. EC sensor arrays 216 and 220 may further be configured to detect finer defects on or within the build pieces 208a-c such as very small cracks or voids. In some embodiments, this method may be used to detect the edges of the build piece (including with the assistance of data from the image sensor 242) and to map progress of the build geometry as it evolves during the additive manufacturing process. In this way, digital representations of the geometry of the actual build piece can be generated as the build piece is being printed, e.g., in real or near-real time. These digital representations of the build pieces 208a-c may be matched against the nominal (CAD) geometry, such as that identified in the original CAD models, to ascertain part accuracy data. The digital representations generated by the sensors may also be used in combination with other process knowledge (such as other known contributors to distortion) after removal of support structures 210a-c, heat treatment and machining, etc. Information from, for example, the EC sensors information can be combined or otherwise used with imaging data from the image sensor 242 to further increase quality assurance in additive manufacturing systems. For example, EC sensors can be capable of sensing phenomena below the surface of the build piece and powder layer, and in fact may be able to sense multiple layers below. Because the energy beam may melt not just the powder layer, but also may melt a portion of the previous powder layer(s) or re-melt a portion of one or more previously-fused layers below, the energy beam may cause irregularities in the geometry of the build piece that cannot be determined by sensing the top surface (e.g., with image sensor 242). In this way, for example, a sensor that can sense below the surface of the build piece and/or powder layer(s) may provide valuable additional information that may be used with the information from a sensor that senses the surface.

More generally, sensor arrays 216 and 220 may be positioned and held at a fixed gap relative to the surface of the deposited powder layer for a stable reference position of the sensor arrays. The sensor arrays 216 and 220 in the embodiment of FIG. 2 are incorporated into the recoater 201. Like in the implementation shown in FIG. 1, sensor array 216 is arranged on one side of the recoater blade 204, and sensor array 220 is arranged on the other side of the recoater blade 204. In this manner, each pass of the recoater 201 can results in two sets of measurements by the EC sensor arrays. These include measurements of the powder bed 247 after printing in a layer but prior to the deposition of the next layer (e.g., spread powder 206), and measurements of the powder bed 247 immediately following the deposition of the next powder layer. Thus, the embodiment of FIG. 2 results in two sets of data sensing the same state of the build (i.e., sensor array 216 senses before spread powder 206 is deposited and sensor array 220 senses after the spread powder is deposited), which may provide higher precision measurements involving potentially more subtle features. For example, these methods may result in detailed sensing of the powder bed 247 with and without a next layer of powder being deposited.

In some embodiments, sensor arrays, such as recoater-mounted sensor arrays, may include a variety of different types of sensors, e.g. in the dual recoater locations on opposite sides of the blade and deposition mechanism (e.g., arrays 216 and 220). For example, with reference to sensor arrays 216 and 220 of FIG. 2, one of the arrays may be an image sensor and the other of the arrays may be a non-image sensor. As another example, in various embodiments a portion of sensor array 216 may be an optical sensor and another portion of the same sensor array 216 may be a non-optical sensor. Further still, sensor 218 can likewise be partitioned in this manner to incorporate both an optical and non-optical sensor. In some embodiments the recoater 201 may have to be built with bigger sensing heads to accommodate the necessary electrical circuits and mechanical components to implement this level of sophistication. In various embodiments, a sensor array may be mounted on only one side of the blade of a recoater with the other side of the recoater having no sensor. In various embodiments, the one or more sensors and/or arrays may be arranged elsewhere in the build chamber (e.g., not on the recoater) or in addition to sensors mounted on the recoater.

In various additional embodiments, imaging sensors can be positioned on the recoater 201 as described above, but the image sensor 242 can remain as an additional source of image sensing, which can advantageously be used during the scanning cycle, e.g., to scan for ejected matter and to determine an initial landing location. The various image and non-image sensor circuitry on the recoater 201 can thereafter perform more precise measurements based on the landing location and additional data than any conventional known 3D printers.

For defect detection, the eddy current sensor or other electrical-based sensor can use electrical or magnetic fields (or in some cases applied current) to determine a target impedance in the area of the powder bed 247 or the build piece 208a-c being sensed. The measurement of target impedance may beneficially enable the sensor arrays 216, 220 or processor(s) (e.g., processor(s) 129) receiving the sensor data to determine and account for potentially unexpected discontinuities in the material, which may increase its measured impedance. Thus, by measuring localized impedance to a high enough spatial resolution, the sensor may flag those impedance values outside of an acceptable range as potential discontinuities in a build piece being printed. These discontinuities may then be fixed, especially if crack initiation has begun to occur. With insufficient spatial resolution, computer simulations may be used to determine the expected impedance measurements and flag deviations from this expected value. Thus computer measurements can further increase the precision of the sensors in identifying unwanted artifacts.

The sensing head(s), e.g., sensor arrays 216 and 220, including eddy-current sensing and/or other sensors, may also be used to detect subsurface voids formed in the material. The rapid melting process in metal additive manufacturing can result in voids that form in the lower layers of the part being printed while the outermost surface may appear perfectly smooth. This detection may advantageously anticipate cracks that may form after subsequent thermal cycling/re-melting in the additive manufacturing process.

Thus, for example, image sensor 242 can monitor the progress of the scan and can flag any unusual anomalies, such as spatter material landing in an area of powder to be fused or in an area of the build piece already fused. Eddy current (EC) sensors (e.g., sensor arrays 216 and/or 220) can use this data to identify whether voids may be present in the lower layers. As an example, the processor(s) 129 (FIG. 1) or the eddy current sensor arrays 216, 220 may not detect any surface discrepancies at a location even though recent image data from image sensor 242 may indicate a potential anomaly at the location, because the surface may appear smooth. However, the processor(s) 129 or EC sensor arrays 216, 220 may rely on older image data from earlier layers, combined with additional measurements by the EC sensor arrays 216, 220 within the layers, to collectively determine that cracks or voids may be present a few layers down within one of the build pieces 208a-c. In this way, for example, non-image sensors may benefit from earlier image readings of prior layers in some cases to assist in determining whether defects are present, and 3D printing may be suspended until these defects are corrected.

Some 3D printer designs utilize a single recoating (powder deposition) direction and other more efficient designs utilize bi-directional recoating. In the case of single-direction recoating, the recoater 201 may commonly be equipped with two sets of sensing heads (a first set and a second set) on either side of the recoater 201. In this single-direction case, one set of sensing heads (e.g., array 216) is always on the leading edge of recoater 201 as the recoater travels to deposit and spread powder 206. The other set of sensing heads (e.g., array 220) is always on the trailing edge of the recoater, because the recoater deposits powder while traveling in one direction only. In the single direction recoating case, similar to the bi-directional recoating case, the sensors on the re-coater may obtain measurements both before and after powder deposition, because one sensor takes measurements before powder deposition and the other sensor takes measurements after.

Conversely, in the case of bi-directional recoating in which the recoater 201 is equipped with two sets (a first array 216 and a second array 220) of sensing heads on either side of the recoater 201, the first set (array 216) is on the leading edge and the second set (array 220) is on the trailing edge when the recoater travels in one direction to deposit powder, and the first set (array 216) is on the trailing edge and the second set (array 220) is on the leading edge when the recoater 201 travels in the other direction to deposit powder.

One advantage of incorporating the sensing head(s) into the recoater 201 as described in FIGS. 1 and 2 is that the eddy current sensing speed (versus other technologies) can be high enough to be tuned to occur concurrently with the required powder depositing step. This configuration can support high throughput printer requirements. For example, in layer-based imaging methods, most often a static picture from a camera requires an extra second or two on each layer, potentially accumulating to add many minutes to a large build job. These embodiments in FIGS. 1 and 2, wherein the eddy current sensors can be included on either side of the recoater 101, allow the sensors to work independently, without adding time to the print job.

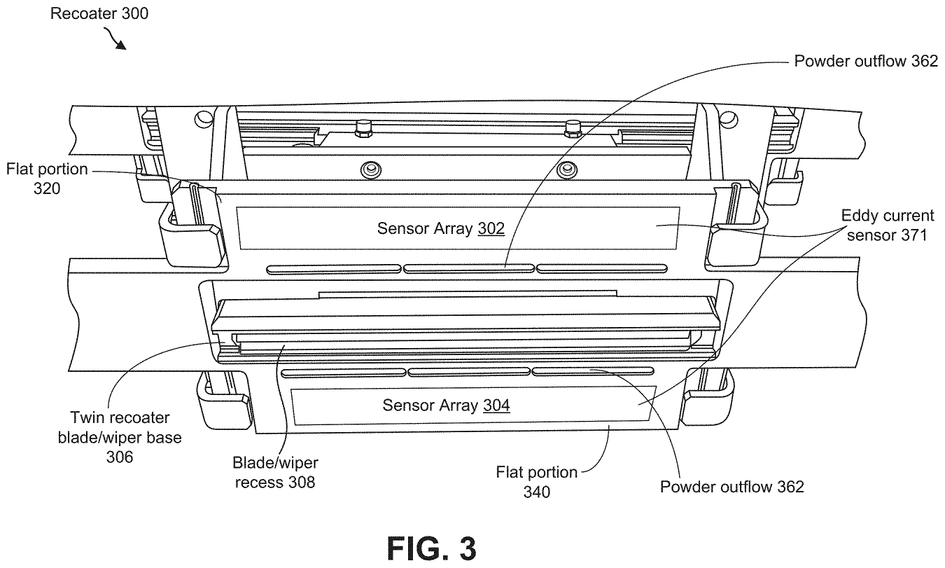

FIG. 3 is a perspective posterior view of a recoater 300 with an integrated eddy-current sensor 371. The perspective orientation of the recoater 300 is from a vantage point looking up and slightly angularly at the bottom of the recoater 300 from the surface of the powder bed 121. The recoater 300 may be a bidirectional recoater. A bidirectional recoater may be configured to deposit print material in both directions traversed by the recoater 300, such as from left to right, and thereafter from right to left (or vice versa). A bidirectional coater can be used to speed up the print job because scans can be performed after the deposition of each layer. The 3D printer does not have to wait for the recoater 100 to return to an originating side before applying the next re-coat.

Recoater 300 includes powder outflow 212, which may correspond to the aperture 177 from which powder can flow in a controlled manner onto the powder bed 121 as the recoater 300 progresses. In some embodiments, recoater 300 can be equipped with a twin recoater blade element or rubber wiper, which may be inserted on the twin recoater blade/wiper base 306 using the blade/wiper recess 308. One leveler 119 (FIG. 1) may be operable to smoothen the deposited layer out as the recoater 300 moves across the powder bed 121 in a first direction. Another leveler may perform the same function, smoothening the deposited layer out when the recoater 300 deposits the print mater in the other direction. In some embodiments, a single blade/leveler is used for both scan directions.

Eddy current sensor 371 may be integrated as an array of sensors 302 and 304, along with associated sensor circuitry, into respective flat portions 320 and 340 of the recoater 300. The illustrated configuration of FIG. 3 allows the eddy current sensor 371 to have additional area close to the powder bed 121 to operate.

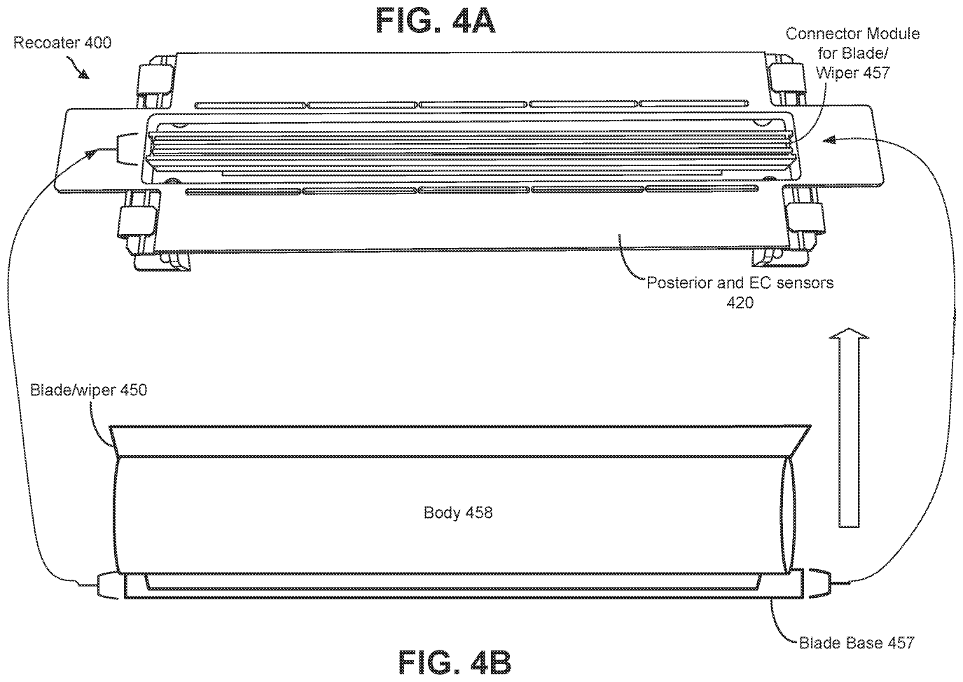

FIG. 4A is a rear perspective view of a recoater 400 including a base with an integrated eddy current sensor. The recoater 400 includes a posterior region 420, within which the eddy current sensor circuitry is built. At the center of the posterior region is a connector module 457. Connector module 457 can be used as a base for affixing a blade or rubber wiper, such as blade 119 in FIG. 1 or blade/wiper 204 of FIG. 2.

FIG. 4B is a perspective view of an exemplary blade or wiper 450 that connects to the recoater of FIG. 4A. The body 458 of the blade 450 is cylindrical in this example, although the physical configuration of the blade 450 may also be flat, or another geometry. Blade 450 can be equipped with a blade base 457 which, as shown by the arrows, is pre-configured to snap into place when coupled to the connector module 457 of the recoater 400 in FIG. 4A. This beneficial arrangement enables the user of the machine to replace the blade or wiper when it becomes dull or worn, without having to replace the entire recoater 400 and electronic sensors within. In other configurations, the blade and recoater may be part of a single unit. In still other examples, the body 458 can be permanently affixed to the recoater 400, but with replaceable blades 450.

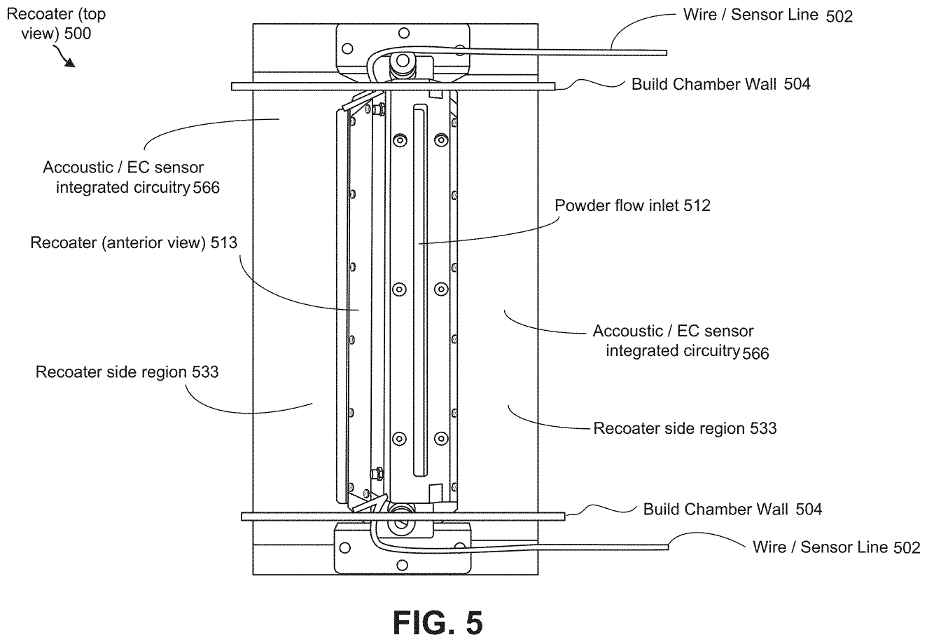

FIG. 5 is a top perspective view of a recoater 500 with an integrated non-optical sensor 566 in a recoater side region 533. The top surface of recoater 500 may include an anterior portion 513 that includes a region where fresh powder can temporarily be stored for use during recoats. Recoater 500 may further include a powder flow inlet 512 for receiving powder from a depositor, hopper, powder drum, or other print material source. The powder flows into the region defined in part by the walls in the anterior view 513.

In the embodiments presented heretofore, with the eddy current sensors integrated in the recoater 500, signals may be transmitted and received for producing and sensing eddy currents (e.g., in one embodiment, by powering an electromagnet that sends magnetic fields into the relevant portions of the powder bed to generate eddy currents). It is also necessary to receive signals that can be tracked to determine the value of the fields or the currents at any given time, to thereby determine impedance values and other measurements that may characterize defects in the print job.

A wide variety of possible methods may be available to provide these signals, each of which is intended to fall within the scope of the present disclosure. For example, various such techniques involve retrieving the eddy current sensing head signals out of the build chamber and to a control box, which may either be incorporated as a modular system external to the 3D printers or which may instead be fully embedded outside the build chamber but otherwise connected to the 3D printer. For example, in one such embodiment, a sensor line, e.g. for power, sensing signals, control signals, etc., can include small wires 502 routed along, or hidden within, the build chamber walls 504. This configuration can minimally impact the air flow uniformity in the print chamber required for solid process performance during the print. The wires 502 for the sensor can be routed through a small aperture in the build chamber walls 504 and thereafter into the eddy current sensor. On the other end, the sensor line can be routed to and from the modular system described above. The modular system in this embodiment is outside the build chamber walls and therefore can generate large currents or perform other functions for the eddy current sensor, without disrupting operation of other aspects of the printer.

Over time, the data from both the various sensors can be used to improve build piece accuracy by comparing as-printed geometry to the nominal geometry. This data may be used to determine if any calibration drift has occurred in the scanning system in the additive manufacturing system. Algorithms may be used to enable a better fit of the as-printed geometry to the nominal geometry. Furthermore, this data may eliminate or reduce other costly destructive and non-destructive inspections including mechanical witness specimen tests, coordinate measuring machines (CMMs) or structured light scans for dimensional verification, x-ray computed microtomography (XCT) for material verification, etc., in non-design specific, flexible, fixture-less manufacturing systems that use additive manufacturing and advanced robotic assembly systems. A dimensional verification step of scanning the additively manufactured build piece and comparing it to the nominal CAD geometry may be performed prior to assembly by advanced robotic assembly systems due to the current state of print accuracy (˜1% typical), and a robotic path may be compensated accordingly using such scan information. In other words, a pre-inspection step comprising dimensional verification by scanning the additively manufactured part and comparing it to the nominal CAD geometry prior to assembly may be required to consider the overall part accuracy, resulting from both the printing accuracy and process accuracy (e.g. post-processing, support removal from 3D printed part, etc.). This pre-inspection step can help infer whether a target geometric variation will be achieved or not. These functions can be integrated within the sensors and processors of the 3D printer described herein.

The present disclosure may also yield other advantages for manufacturing techniques that may follow the 3D printing. For example, the 3D printed build piece may subsequently be assembled into a larger part. This larger part may be a vehicle, an aircraft, spacecraft, and another type of transport device. In some cases, the larger part may be a machine that may or may not have any mobility or transport functions. The various sensor data obtained during the 3D printing step can, in various embodiments, be used to streamline the assembly of the 3D printed part, such as when the subsequent assembly is performed at a robotic station. The robotic station may be a cell in the same facility, or it may be off-site. The imaging and non-optical data gathered during 3D printing can be transferred to the robotic assembly station and used to ensure coherent assembly of the 3D printed part, often, but not necessarily, on a fully automated basis. Thus with or without recognized defects, the detailed geometric and compositional data gathered during the 3D printing of the build piece may be invaluable for use by the robotic station in the subsequent assembly.

In various embodiments, incorporating the eddy current sensing systems with the image sensing systems, for example, the data traceable to the build piece in the printer (the part accuracy) may be used to guide robotic path compensation to account for distortion/variation with respect to nominal characteristics of the CAD part model during a subsequent robotic assembly process involving the printed part. This technique is sometimes known as “move, measure, correct.” In these embodiments, the build piece accuracy as tracked by the 3D print sensor data can provide additional detail to a subsequent advanced robotic assembly involving the part, potentially avoiding pre-inspection of the printed part. In short, the data gathered by the sensors during the printing of the build piece may be used in significant applications for characterizing the part after the print.

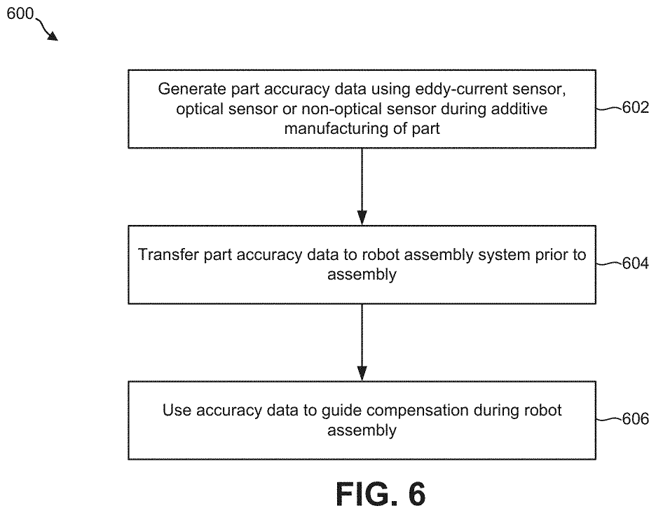

FIG. 6 is a flow chart of an example method of using sensor data from multiple sensors in a 3D printer. At 602, during printing, build piece accuracy data can be generated using an eddy current sensor, an optical sensor, a non-optical sensor, or some combination thereof. This information can be maintained in a memory (such as computer-readable medium 155 of FIG. 1) on the 3D printer. As an example of this step, the eddy current sensor in the 3D printer may provide edge detection data from each of the layers. These edges can be combined to form a three-dimensional representation of the build piece geometry. In various embodiments, the eddy current data can in the 3D printer include a sensed depth of different locations in each power layer, and the sensed depth data may be used to refine the representation of the part geometry. The build piece accuracy data may then be transferred to the robotic assembly system as described in FIG. 6 (step 604), to be used to make any necessary corrections when the 3D part is installed within the vehicle or other assembly.

At 604, the sensor data in the memory (e.g., memory 155) can, after the print, be transferred to a separate robot assembly system prior to assembly of the build piece, e.g., within a vehicle or other mechanized assembly. Thus, for example, the controller bus 174 of FIG. 1 can in some cases be networked to other stations in a manufacturing facility, including a robot assembly cell.

At 606, the data used to determine the accuracy of the 3D print job can also be used to guide installation during the robotic assembly into the larger mechanical structure. This may include using the 3D print data to compensate for prospective deviations from the 3D CAD print model, for example, and the build piece. In various embodiments, all of these techniques can be performed automatedly, without the requirement of manufacturer intervention.

As an example of 606 of FIG. 6, when guiding compensation during robotic assembly, the robotic assembly system may use adhesive to structurally bond the parts together by filling a groove in one additively manufactured part and inserting the tongue of another additively manufactured part into the adhesive-filled groove to bond the parts together. In this case, the build piece accuracy data generated from the eddy current sensing may be used to guide compensation during robotic assembly. For example, the part accuracy data might show that a build piece is two (2) mm too short along the direction that the part will be joined with another part. In this case, the robotic assembly system might use the build piece accuracy data to guide compensation such that the robot moves the build piece an additional 2 mm in the joining direction to ensure the part is successfully bonded to the other part. On the other hand, the system may determine to move the build piece only an additional 1 mm in the joining direction, so that the bond can be successful with a minimum impact on the dimensional accuracy of the entire assembly.

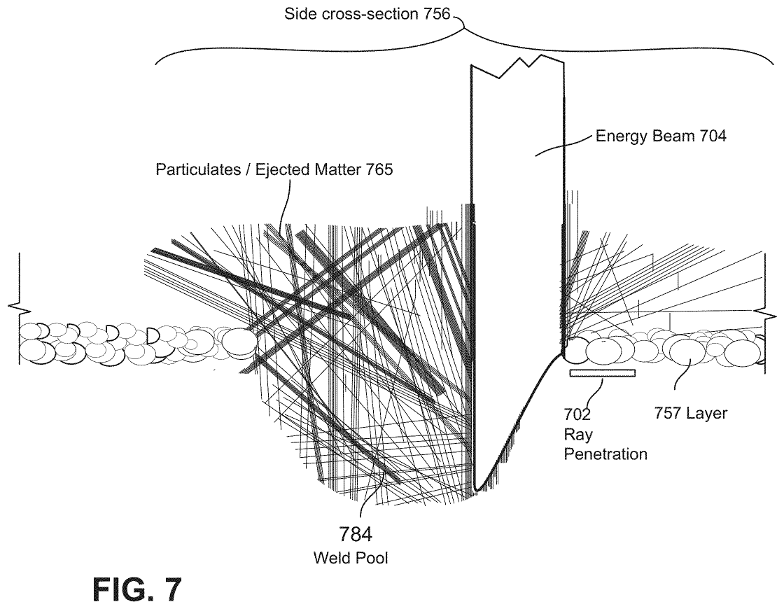

FIG. 7 includes side cross-sectional and top views of an example weld pool in multiple build layers. The 3D printer in this illustration uses a laser. The illustration shows a side view 756 of a layer 757 and a weld pool 784. In the side view 756, a laser beam 704 is moving to the right and is creating the weld pool 784 using a predefined power. In the illustrated example, the weld pool depth extends to about 100 μm, or microns. As is evident from the illustration, the portion of layer 757 that has yet to be struck with the laser beam 704 has less ray penetration 702. By contrast, the left portion of the side view 765 shows substantial particulates and other matter ejected from the weld pool 784.

Some of this matter may fall back down into the weld pool and solidify as normal. Other portions of the ejected matter may be so small such that they would be deemed not significant, or at least not of enough volume to cause noticeable flaws in the build piece or performance problems. For example, small, high velocity particles pose a relatively low risk to build quality and are highly likely to be carried away with the gas stream within the build chamber away from the powder bed. A more significant event may be a large spatter particle which may be likely to fall back into the powder bed or build piece. In general, such large spatter may be expected to move slower than the weld pool's movement across the surface of the powder bed.

An even more significant event may occur where this ejected matter particle falls into an area of the build volume occupied by the component being manufactured—namely, the build piece itself. As described above, much of such ejected matter may include (i) various ceramic compounds (carbides, silicides, oxides or nitrides), or (ii) intermetallics of the metallic powder alloy constituents. These categories of ejected matter are likely to be resistant to re-melting and, as such, can potentially create an inclusion. Where an inclusion is present, more likely than not, some amount of powder material underneath the ceramic/intermetallic matter may remain in powder form due to inefficient or no sintering due to the inclusion blocking the laser source. Partially sintered or un-sintered powder material may cause premature failure in the finished product, if left unaddressed.

In short, while some of the high velocity smaller particulates from the weld pool vicinity may be less significant, some of the ejected matter may be big enough and hot enough to have a trajectory sufficient to cause the ejected matter to fall into another portion of the build. The heat carried by the ejected matter can cause damage to the layers or portions of the build piece on which it lands. These types of ejected material can be imaged by the image solutions to determine a trajectory and landing location. Other sensors, e.g., non-optical sensors, or a combination of non-optical sensors, may use this landing information to identify the features of the ejected material, whether the area underneath the landing location is unmelted or partially melted where it otherwise should be a solid portion of the build piece, and other characteristics that may be ideal or a non-optical sensor.

Various embodiments may include tagged monitoring of the area of the weld pool with the eddy current sensing system, an acoustic sensor, etc. for a prescribed number of n build layers. The inclusion can be monitored for evidence of crack initiation. Builds may be stopped or flagged for later repair/inspection as warranted. It may be desirable to continue the print job until more than one, or a number, of defects are identified. That way the 3D printer can efficiently continue without interruption, as the builds are flagged for later repair or further inspection. In some embodiments, processor 129 (FIG. 1) can instruct the printer to print a physical marking on the outside of a build piece to indicate the location of the inclusion. The defects can later be addressed in post-processing stages. In some embodiments, the defects can be addressed by suspending printing before it is complete, such as at a time where the processor 129 may determine that the printer is at a stage where repairs should no longer be deferred.

In embodiments where the inclusion is later determined by sensors to be trapped internally in the part, a conduit can be 3D printed as a feature with the part to provide mechanical or fluid access to the inclusion. Referring back to FIG. 3, it is assumed for simplicity that inclusion 693 (enlarged for illustrative purposes) had been previously ejected from the weld pool.

This 3D printed conduit can enable removal of the inclusion via a mechanical removal (e.g. machining tool or vacuum), or use of chemical agents. Referring briefly to FIG. 2, after the inclusion 293 is removed, the conduit can be filled with the parent material, casting material, or any other suitable material to occupy the void left by the inclusion 293. Conduit 292 may be filled in by 3D printing (e.g., by another 3D printer) in a size that is commensurate with the inclusion 293. 3D printing may be suspended while the conduit 292 is inserted into the powder bed 247 and the inclusion 293 is removed.

In more complex cases where an inclusion is oriented such that it covers unsintered print material that is part of a printed part itself, a conduit can first be 3D printed and used to remove the inclusion 293. The conduit can then be filled with molten print material, or other material in liquid form that solidifies at room temperature and that has features consistent with that of the build piece from which the unmelted powder originated. Additional layers can be added, via the conduit or otherwise, and then melted to reinforce the part, or to substitute for that portion of the build piece that was occupied by the inclusion.

In various embodiments, the sensors may act in concert with the processor(s) and other systems to form a closed repair loop. As shown in FIG. 1, an automated machine tool 184 can use a robotic arm 185 to perform automated repairs based on data gathered from the sensors. In other embodiments, the 3D printer/sensor system 100 may include a vacuum, brush, scraper, or other type of tool in addition to or instead of the robotic arm 185 to remove the defective area and initiate an in-situ repair.

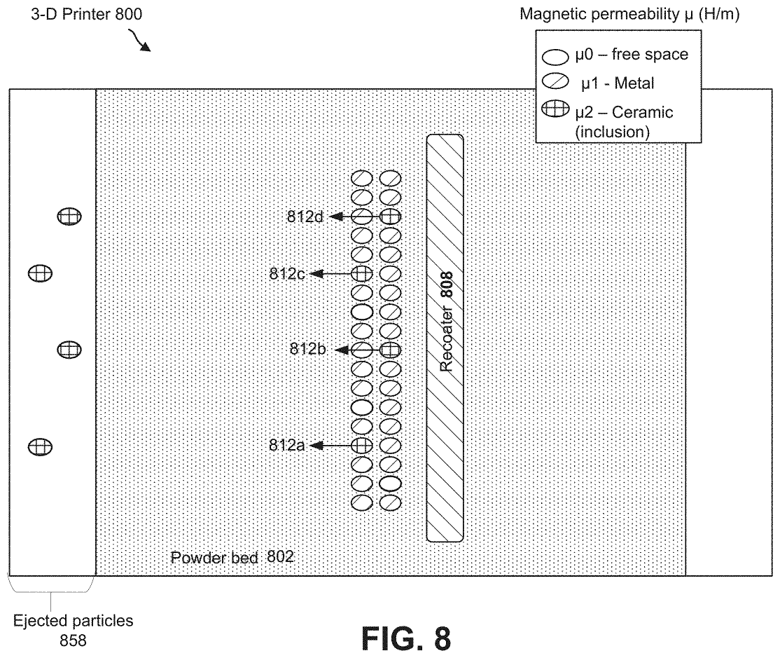

FIG. 8 is a top view of a powder bed 802 and recoater 808 of a 3D printer 800 illustrating the use of magnetic properties of eddy currents to help remove defects. In the case that the printed material is magnetic or paramagnetic, eddy current settings can be adjusted such that a magnetic force is introduced to the powder bed 802, thereby placing the powder bed 802 into an excited mode. In some embodiments, the recoater blade may be used to induce a magnetic field.

Due to the difference in magnetic properties and the reactions of the ceramic inclusion and metal, the inclusions can be identified based on their permeability and then expelled, using magnetic fields, from the powder bed. Once the inclusions are removed, the magnetic field can be adjusted to increase and excite the metal particles even more, filling the void left by the inclusion as well as any empty space.

The exemplary embodiment of FIG. 8 shows different particles in the powder bed 802 that have different magnetic permeabilities μ. A first area having a first type of marks corresponds to a magnetic permeability of μ0, which represents a metal in the powder bed. A second particle type corresponds to the metallic print material used in the different layers of the powder bed 802, which has a permeability of μ1 and corresponds to the print material in use. A third particle type has a magnetic permeability of μ2 and corresponds to a ceramic, or in some embodiments, an intermetallic material that is an inclusion.

As noted above, the eddy current settings can be configured to identify defects in the powder bed that may cause a reaction shown by arrows 812a-d to selectively cause the ceramic particles (potential inclusions) with permeability μ2 to be identified distinctly from the powder bed 802. The ejected particles are shown as particles 858. Accordingly, eddy current sensors can be used for both magnetic and paramagnetic materials to selectively identify defects in the powder bed and to fill void regions with print material as needed.

In some embodiments, other tools, including robotic arm 185 (FIG. 1) or a 3D printed conduit may be used to help complete the removal of the inclusions out of the powder bed 802, in such embodiments where further assistance is necessary. In various additional embodiments, different parameters may be locally modified to re-melt or breakdown the inclusion or spatter. In yet additional embodiments, chemical agents such as reducing acids can also be used to locally dose the spatter to dissolve the spatter after the image sensors identify the spatter's landing location.

In various embodiments, additional powder can be laid down or coated, whether as a layer or selectively in different locations of the powder bed 702, after which an additional laser exposure may be used to re-melt the defective areas. Using this technique, build pieces can be strengthened by removing unmelted powder that may be identified by the combined sensor system. In still additional embodiments, the 3D printer's recoating action can also be used to remove spatter of a certain size (such as, for example, a size larger than 60% of the layer thickness), mechanically from the top layer.

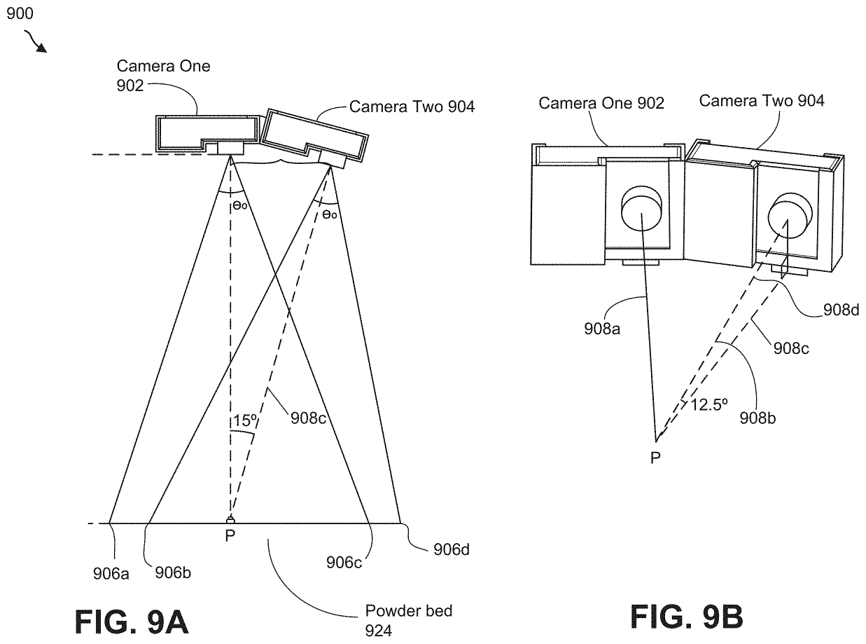

In further embodiments, the image sensors can be positioned in a 3D printer in a manner that provides a three-dimensional representation of potential spatter and other defects during the heating of the print material to form the weld pool. FIG. 9A is a side view of two cameras oriented to image a powder bed surface in three dimensions. While two cameras are shown for simplicity, in a 3D printer a plurality of cameras may be distributed in the manner shown at different orientations both above and along the sides of the powder bed.

In FIG. 9A, camera one 902 is positioned such that a far point of the camera is orthogonal to point P on the powder bed 924. The field of view of camera one 902 extends to, and is defined by, points 906a and 906c on powder bed 924. The total angle representing the field of view is shown by the angle θ°.

Camera two 904 is positioned at an angle of 15° from camera one 902. This is shown by the dashed line of camera two 904 terminating at point P of the powder bed and forming an angle of 15° with the dashed line corresponding to camera one 902. Camera two 904 also has a field of view of angle θ° onto the powder bed 924 extending between points 906b and 906d, as shown by the two intersecting dashed lines at point P labeled 908c on powder bed 924.

FIG. 9B is a front perspective view of the two cameras of FIG. 9A from a vantage point (looking up at the cameras) at a surface of the powder bed 924. As shown in camera one 902, the center of the lens meets the dashed line of camera one 902 via line 908a to point P. Meanwhile, as shown in camera two 904 in FIG. 9B, the lower portion of the camera forms a right triangle with point P, which in turn forms an angle of 12.5° from the lower portion to the center of the lens. These orientations and their relationships to point P on the powder bed allow the two cameras to take a three-dimensional image of the powder bed. Thus the cameras 902, 904, which can also be video feeds, can capture the trajectory of ejected matter in three dimensions. Meanwhile, their fields of view can be configured wide enough to capture the landing locations of the ejected matter that may occur anywhere on the build piece. In other embodiments where larger fields of view may be needed, additional pairs of complementary cameras may be positioned or fixed above the powder bed. Where room is scarce, the cameras can instead be limited in number but can be configured to have movable lenses to change the field of view, or movable bodies so that the cameras can be pivoted based on factors like the size of the current build piece.

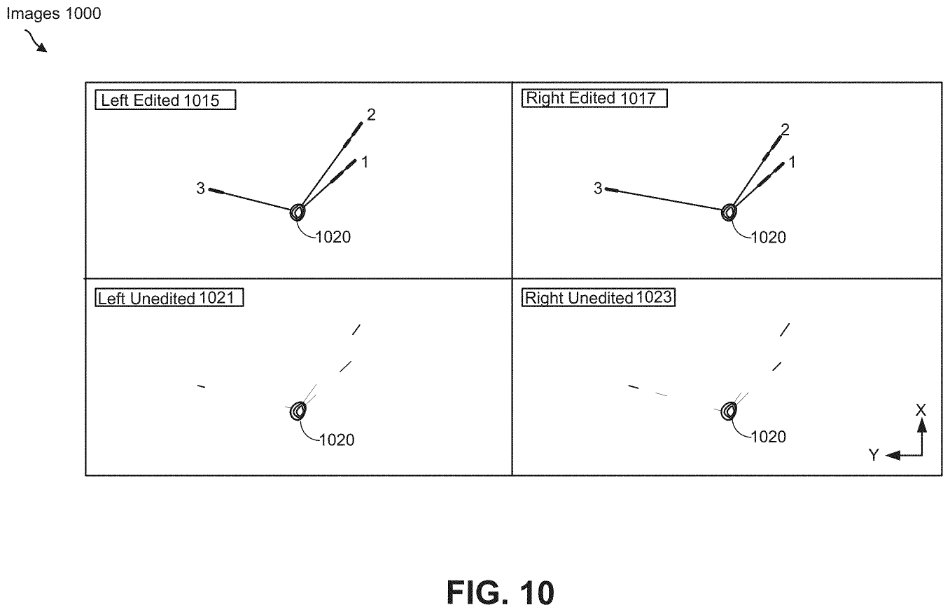

FIG. 10 is a conceptual diagram with different images 1000 of a trajectory of matter 1020 ejected from a weld pool. In the unedited versions of the cameras left and right images 1021 and 1023, the images are not lined up to produce a three-dimensional trajectory as described above with respect to FIG. 9A-B. Ejected matter particle 1020 can be viewed at an originating point in or near the weld pool, but the fragmenting from the particle 1020 in each image is significantly faded. By contrast, using the edited three-dimensional left and right images, the three components of spatter 1, 2 and 3 are not only more clearly seen, but the angles and positions of the cameras can be used with the recorded position of the ejected matter particles on the photos to determine the trajectories of all three fragments 1, 2 and 3.

In other aspects of the disclosure, 3D printers can be installed with separately, or manufactured and integrated with, combined sensor systems that include special image detector for phenomenon like plumes and spatter. Plumes and spatter are defects that can occur in systems such as selective laser melting (SLM) and similar 3D printers.

In addition to combining types of sensor systems, in one aspect of the disclosure, novel image sensors can be installed with or integrated into 3D printers for providing views with different resolutions and from different angles. In some embodiments, image sensors can be adjusted to differentiate plumes and spatters. A plume can be identified as the gas or the vapor that evolves off the weld pool. Plume and light spatter is generally less important than the heavier spatter, or matter particles that can cause damage to the build piece. In some embodiments, the image sensors are configured such that, while both plume and spatter are imaged, they are imaged in a way that the processor's software can distinguish the two.

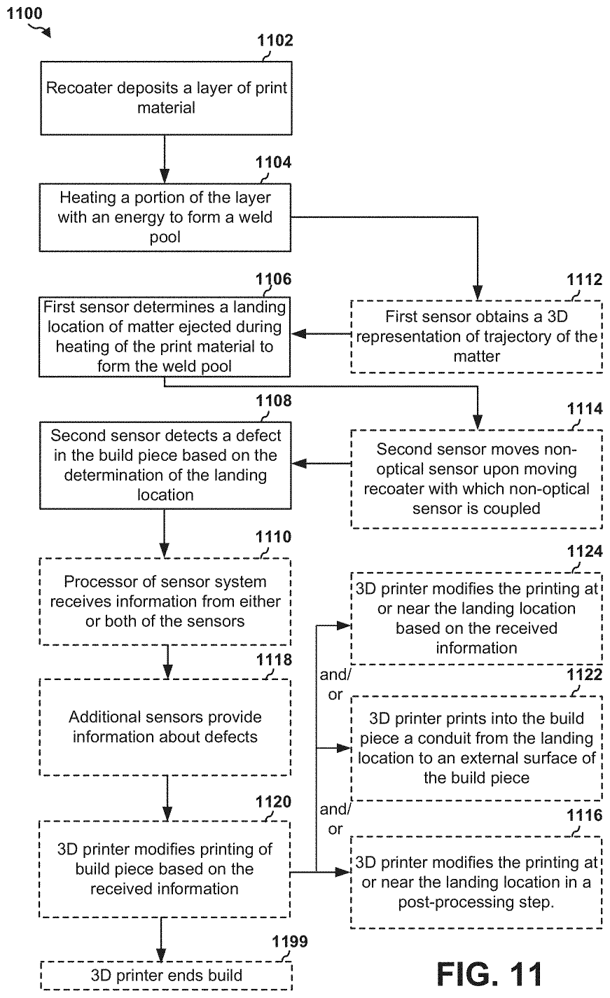

FIG. 11 is a flowchart 1100 of methods for using a multiple sensor system to, for example, identify and repair defects during printing. While FIG. 11 shows various embodiments, it will be appreciated by those skilled in the art that the flowchart illustrates techniques for using multiple sensors in certain embodiments, and that other embodiments may equally be contemplated without departing from the scope of the present disclosure.

The methods in FIG. 11 can be performed by any of the sensor systems and 3D printers described above. The methods can be performed using the recoaters and the image sensors described herein, and any of the configurations and variations described in this disclosure. In various embodiments, dashed blocks in the figure may be considered optional. One or more such blocks may correspond to steps that may or may not be included depending on the configuration of the 3D-printer and the objective for the sensors in a given embodiment.

Beginning at 1102, the recoater of a 3D printer deposits a layer of print material onto a powder bed. At 1104, and as typically performed in between successive deposition cycles of 1102, an energy beam such as a laser beam forms a weld pool that defines portions of the build piece once the weld pool hardens. That is, the laser or other energy beam source heats the intended print material to thereby melt the material so that the material can fuse into an intended portion of the build piece. The beam is configured to avoid striking the layers that do not form parts of the build piece.

At 1106, one or more first sensors—which may include virtually any type of imaging device, whether in the infrared, visible or ultraviolet spectrum, for example, and regardless of whether one or multiple shots are taken, or video streams are taken, or both—determine a landing location of matter that is ejected during the heating of print material to form the weld pool. For example, the first sensors may sense first information, such as optical images of ejected matter, and the processor can determine, based on the first information, a landing location of the ejected matter.

In an exemplary embodiment, the first sensor may include a first camera adjacent a second camera, and at 1112, the sensor may obtain a three-dimensional representation of a trajectory of the ejected matter. Based upon a known orientation, one or more position measurements, or other measurements such as velocity (using a timing measurement), can be taken and provided to the processors or the print controller as data for use in a subsequent closed loop repair process, or in manual repair processes.

At 1108, a second sensor, such as an optical sensor, an acoustic sensor, an eddy current sensor, a capacitive sensor, a seismic sensor, a non-optic sensor, etc., may detect a defect in the build piece based on the determination of the landing location as provided by one or more of the image sensors. The information from the image sensor may, for example, have been forwarded to the processor via memory, and with other known initial conditions or factors, the processor may compute the necessary information. In other embodiments, the landing location is determined directly by the image sensors, and this data is provided promptly to the processors and non-optical sensors for further use.

In some embodiments, the second sensor system, such as the eddy current, may be coupled with the recoater. Thus the sensor system may move the non-optical sensors upon moving the recoater, as described in 1114. Other types of sensors may in some arrangements also be coupled with the recoater. If not directly coupled with the recoater, the sensors may otherwise be designed to keep pace with (or shortly behind) the recoater using an optional mounting feature.

At 1110, the processor receives information from either one or both of the sensors. The information from the image sensor may include velocity information or other information that may have been computed at the sensor. In other embodiments, the processor performs calculations based on the received images. The information from the eddy current sensor, for example, may include the magnitudes of the eddy currents, the amplitudes and directions of the generated magnetic (or electric) fields, impedances computed based on the generated fields and currents, and other values relevant to the defects. That is, in 1118, additional sensors may be configured to measure information about defects in the build piece and may provide the additional necessary information about the defects to the processor(s).

At 1120, the 3D printer may modify the printing of the build piece based on the received information. For example, in one embodiment, the 3D printer may be configured to 3D print a mark, tag, number or flag on a portion of the build piece that has a defect, so that the defect can be addressed at a subsequent time. In other embodiments discussed above, the 3D printer may suspend printing, repair the defect promptly, and then resume printing.

At 1124, the 3D printer modifies the printing. In various embodiments, the 3D printer may modify the printing, e.g., at or near the landing location of the ejected matter based on the information received from the sensors. In various embodiments, the 3D printer may take other action such as stopping the build, such as at 1199. Thus a closed loop system can be achieved to repair or take other action. At 1122, the 3D printer may print into the build piece a conduit, as discussed above with as a brush, blade, drill, sander, polisher, or other machining device of the 3D printer to perform the correction.

Based upon the complementary information retrieved by more than one sensor type, the 3D printer may have significant advantages reference to FIG. 3, and may use the conduit at or near the landing location to extract or chemically dissolve the foreign matter or particle. At 1116, the 3D printer may determine to modify the post processing of the build piece at or near the landing location. For example, the 3D printer may have earlier tagged a mark on a defective region on a build piece. The 3D printer may generate instructions for a machining tool or robotic arm to correct or repair a defect in the build piece during post-processing after the printing has been completed. In various embodiments, the 3D printer may perform in situ techniques, including using other tools such over conventional approaches. In some embodiments, the 3D sensor system may be a separate apparatus or more than one apparatus that can be assembled with, coupled to, or otherwise integrated with the 3D printer. In other embodiments, the 3D printer may come pre-assembled with the sensor systems. In further embodiments as noted above, a number of different types of 3D printers may be used herein and remain within the scope of the present disclosure.

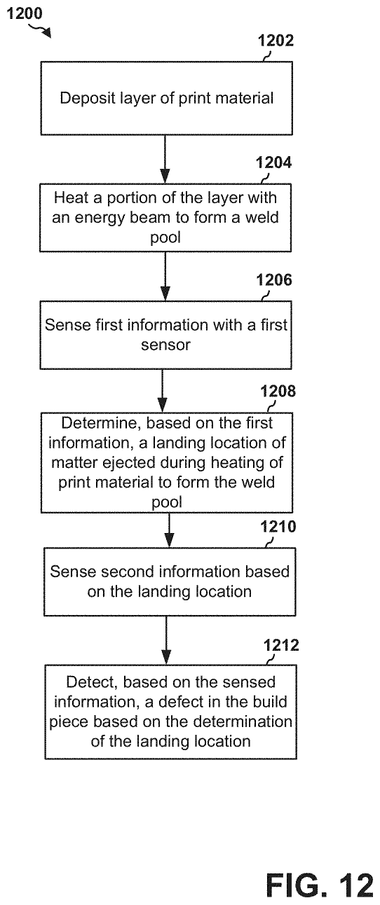

FIG. 12 is another flowchart 1200 of methods for using a combined sensor system to identify and repair defects in a 3D printer. The 3D printer system that may be used to perform the steps in FIG. 12 may include any of the systems described in this disclosure, using any of the described recoaters or other equipment. At 1202, the 3D printer may deposit a layer of print material, e.g., onto a print substrate or a previous layer. At 1204, the 3D printer can use its laser or other energy beam source to heat a portion of the layer to form a weld pool.

At 1206, the 3D printer system may sense first information with a first sensor, such as an image sensor, for example. Based on the first information, the 3D printer system may determine a landing location of matter ejected during the heating of print material to form the weld pool, such as shown in 1208. Having determined the location of the matter, the 3D printer system can then use a sensor to sense second information based on the landing location (1210). The sensor may be the image sensor, or it may be an eddy current sensor, etc. At 1212, the 3D printer system, based on the sensed information and the determination of the landing location, may detect a defect in the build piece. Various remedial measures may be taken by the 3D printer system at that point as described in detail herein, or in other cases, the information may just be report for later use.

The previous description is provided to enable any person skilled in the art to practice the various aspects described herein. Various modifications to these exemplary embodiments presented throughout this disclosure will be readily apparent to those skilled in the art. Thus, the claims are not intended to be limited to the exemplary embodiments presented throughout the disclosure, but are to be accorded the fu011 scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A sensor system for a three-dimensional (3D) printer, comprising:
a first sensor configured to determine a landing location of matter ejected during heating of print material to form a weld pool, wherein the weld pool defines a portion of a build piece once the weld pool hardens; and
a second sensor configured to detect a defect in the build piece based on the determination of the landing location.

2. The sensor system of claim 1, wherein the second sensor comprises an eddy current sensor.

3. The sensor system of claim 2, wherein the defect comprises at least an inclusion, a subsurface void, a region of partially sintered print material, or a region of unsintered print material.

4. The sensor system of claim 1, wherein the first sensor comprises a camera.

5. The sensor system of claim 4, wherein the first sensor comprises a first camera adjacent a second camera, such that the first camera is oriented relative to the second camera to obtain a three-dimensional representation of a trajectory of the matter.

6. The sensor system of claim 1, wherein the second sensor is coupled with a recoater of the 3D printer, such that the second sensor is configured to move with the recoater.

7. The sensor system of claim 1, further comprising at least one processor configured to receive information from at least the first sensor or the second sensor.

8. The sensor system of claim 7, wherein the received information includes images of the matter.

9. The sensor system of claim 7, wherein the at least one processor is further configured to modify printing of the build piece based on the received information.

10. The sensor system of claim 9, wherein modifying the printing of the build piece includes modifying the printing at or near the landing location.

11. The sensor system of claim 10, wherein fused powder material is located at the landing location, and modifying the printing at or near the landing location includes instructing the 3D printer to re-melt the fused powder material.

12. The sensor system of claim 9, wherein modifying the printing of the build piece includes modifying the printing to include printing into the build piece a conduit from the landing location to an external surface of the build piece.

13. The sensor system of claim 9, wherein modifying the printing of the build piece includes suspending printing.

14. The sensor system of claim 13, wherein the at least one processor is further configured to instruct the 3D printer to remove the matter using at least a vacuum, a brush, a scraper, a machining tool, or a chemical agent.

15. The sensor system of claim 7, wherein the at least one processor is further configured to determine whether the received information meets a criterion for suspending printing to perform a repair.

16. The sensor system of claim 15, wherein the at least one processor is further configured to instruct the 3D printer to refill a void in the build piece created by the repair prior to resuming the printing of the build piece.

17. The sensor system of claim 7, wherein the at least one processor is further configured to determine, based on the received information, at least a trajectory, a velocity, a size, or a material composition of the matter.

18. The sensor system of claim 1, wherein the matter includes a ceramic compound or an intermetallic alloy.

19. The sensor system of claim 1, wherein, when the print material is magnetic or paramagnetic, the second sensor is configured to adjust a magnetic field to expel the matter from the landing location.

20. The sensor system of claim 19, wherein after expelling the matter, the second sensor is configured to adjust an intensity of the magnetic field to excite the print material in the landing location sufficiently to refill a void left by the expelled matter.

21. A three-dimensional (3D) printer, comprising:
a build plate;
a recoater configured to successively deposit layers of print material onto the build plate;
an energy beam source configured to form a weld pool by heating selected regions of the print material in each layer to form a build piece;
an image sensor configured to image an area including the weld pool to determine a landing location of matter ejected during the heating of the print material to form the weld pool; and
a non-optical sensor configured to detect a defect in the build piece based on the determination of the landing location.

22. The 3D printer of claim 21, wherein the non-optical sensor comprises an eddy current sensor.

23. The 3D printer of claim 21, wherein the defect comprises at least an inclusion, a subsurface void, a region of partially sintered print material, or a region of unsintered print material.

24. The 3D printer of claim 21, wherein the image sensor comprises a camera.

25. The 3D printer of claim 21, wherein the image sensor comprises a first camera adjacent a second camera and oriented relative to the second camera to obtain a three-dimensional representation of a trajectory of the matter.

26. The 3D printer of claim 21, wherein the non-optical sensor is coupled with the recoater and is configured to move with the recoater.

27. The 3D printer of claim 21, further comprising at least one processor configured to receive information from at least the image sensor or the non-optical sensor.

28. The 3D printer of claim 27, wherein the received information includes images of the matter.

29. The 3D printer of claim 27, wherein the at least one processor is further configured to modify printing of the build piece based on the received information.

30. The 3D printer of claim 29, wherein the at least one processor is further configured to modify the printing at or near the landing location.

31. The 3D printer of claim 30, wherein fused powder material is located at the landing location, and the at least one processor is further configured to instruct the 3D printer to re-melt the fused powder material.

32. The 3D printer of claim 29, wherein the at least one processor is further configured to modify the printing to include printing into the build piece a conduit from the landing location to an external surface of the build piece.

33. The 3D printer of claim 29, wherein modifying the printing of the build piece includes suspending printing.

34. The 3D printer of claim 33, wherein the at least one processor is further configured to instruct the 3D printer to remove the matter using at least a vacuum, a brush, a scraper, a machining tool, or a chemical agent.

35. The 3D printer of claim 27, wherein the at least one processor is further configured to determine whether the received information meets a criterion for suspending printing to perform a repair.

36. The 3D printer of claim 35, wherein the at least one processor is further configured to instruct the recoater or a re-filler element arranged with the 3D printer to refill a void in the build piece created by the repair prior to resuming the printing of the build piece.

37. The 3D printer of claim 27, wherein the at least one processor is further configured to determine, based on the received information, at least a trajectory, a velocity, a size, or a material composition of the matter.

38. The 3D printer of claim 21, wherein the matter includes a ceramic compound or an intermetallic alloy.

39. The 3D printer of claim 21, wherein, when the print material is magnetic or paramagnetic, and the non-optical sensor is configured to adjust a magnetic field to expel the matter from the landing location.

40. The 3D printer of claim 39, wherein after expelling the matter, the non-optical sensor is configured to adjust an intensity of the magnetic field to excite the print material in the landing location sufficiently to refill a void left by the expelled matter.

41. A method for 3D printing a build piece, comprising:
depositing a layer of print material;
heating a portion the print material in the layer with an energy beam to form a weld pool;
sensing first information with a first sensor;
determining, based on the first information, a landing location of matter ejected during the heating of the print material to form the weld pool;
sensing second information based on the landing location; and
detecting, based on the second information, a defect in the build piece based on the determination of the landing location.

42. The method of claim 41, wherein the second sensor comprises an eddy current sensor.

43. The method of claim 41, wherein the first sensor comprises first and second cameras.

44. The method of claim 43, further comprising orienting the first camera adjacent the second camera, wherein the first information includes a three-dimensional representation of a trajectory of the matter.

45. The method of claim 41, further comprising moving the second sensor upon moving a recoater of the 3D printer, wherein the second sensor is coupled with the recoater.

46. The method of claim 41, further comprising receiving, by at least one processor from at least the second information.

47. The method of claim 46, wherein receiving the second information includes receiving images of the matter.

48. The method of claim 46, further comprising modifying printing of the build piece based on the second information.

49. The method of claim 46, further comprising modifying the printing at or near the landing location based on the second information.

50. The method of claim 49, wherein modifying the printing at or near the landing location includes instructing the 3D printer to re-melt fused powder material.

51. The method of claim 48, wherein modifying the printing of the build piece includes modifying the printing to include printing into the build piece a conduit from the landing location to an external surface of the build piece.

52. The method of claim 48, wherein modifying the printing of the build piece includes suspending printing.
